(19) United States
(12) Patent Application Publication
(10) Pub. No.: US 2020/0211122 A1
(43) Pub. Date: Jul. 2, 2020

(54) ARTIFICIAL INTELLIGENT SYSTEMS AND METHODS FOR RECOMMENDING AT LEAST ONE INSURANCE COMPANY

(71) Applicant: BEIJING DIDI INFINITY TECHNOLOGY AND DEVELOPMENT CO., LTD., Beijing (CN)

(72) Inventors: Hao CHEN, Beijing (CN); Shipeng LI, Beijing (CN); Kun WANG, Beijing (CN)

(73) Assignee: BEIJING DIDI INFINITY TECHNOLOGY AND DEVELOPMENT CO., LTD., Beijing (CN)

(21) Appl. No.: 16/817,751

(22) Filed: Mar. 13, 2020

Related U.S. Application Data
(63) Continuation of application No. PCT/CN2018/092736, filed on Jun. 26, 2018.

(30) Foreign Application Priority Data
Sep. 15, 2017 (CN) 201710831094.0

(51) Int. Cl. G06Q 40/08; G06Q 30/06; G06F 17/18

(52) U.S. Cl. CPC G06Q 40/08; G06F 17/18; G06Q 30/0631

(57) ABSTRACT

Systems and methods for recommending at least one insurance company to a driver are provided. A method includes: obtaining business data of at least one insurance company; for each of the at least one insurance company, determining a company score based on the business data of the insurance company; determining a company ranking of the at least one insurance company based on the at least one company score; obtaining driving data of the driver; determining a driver score based on the driving data of the driver; and determining at least one recommended insurance company based on the company ranking of the at least one insurance company and the driver score of the driver.

### CROSS-REFERENCE TO THE RELATED APPLICATIONS

This application is a continuation of International Application No. PCT/CN2018/092736, filed on Jun. 26, 2018, which claims priority of Chinese Patent Application No. 201710831094.0, filed on Sep. 15, 2017, the contents of which are hereby incorporated by reference.

### TECHNICAL FIELD

The present disclosure generally relates to a technical field of data processing, and more particularly, systems and methods for recommending at least one insurance company to a driver.

### BACKGROUND

Online car-hailing service has become a new travel mode and become a travel choice of more and more people. Vehicle insurance is important for business vehicles used for the online car-hailing service. A problem with the exiting technology of choosing vehicle insurance is that when buying a vehicle insurance a driver often gets confused with how to select an insurance company or selecting which insurance company. Also, an improper insurance company that a driver selects may results in a waste of resources between the driver and the selected insurance company. Accordingly, it is desirable to provide systems and methods for matching at least one proper insurance company to a driver.

### SUMMARY

An aspect of the present disclosure introduces a system of one or more electronic devices for recommending at least one insurance company to a driver, comprising: at least one storage medium including a set of instructions for recommending at least one insurance company to the driver; and at least one processor in communication with the storage medium, wherein when executing the set of instructions. The at least one processor is directed to: obtain business data of at least one insurance company; for each of the at least one insurance company, determine a company score based on the business data of the insurance company; determine a company ranking of the at least one insurance company based on the company score of the at least one company; obtain driving data of the driver; determine a driver score based on the driving data of the driver; and determine at least one recommended insurance company based on the company ranking of the at least one insurance company and the driver score of the driver.

In some embodiments, the business data of the at least one insurance company includes at least one of a number of insured drivers or a ratio of the number of insured drivers to a number of drivers who successfully bid at the at least one insurance company.

In some embodiments, for each of the at least one insurance company, to determine the company score, the at least one processor is further directed to: determine the company score based on the business data according to a first formula, wherein the first formula is Company score=4×[x₁₁−min(x₁₁, x₁₂, . . . , x₁ₙ)]/[max(x₁₁, x₁₂, . . . , x₁ₙ)−min(x₁₁, x₁₂, . . . , x₁ₙ)]+6×[x₂₁−min(x₂₁, x₂₂, . . . , x₂ₙ)]/[max(x₂₁, x₂₂, . . . , x₂ₙ)−min(x₂₁, x₂₂, . . . , x₂ₙ)], wherein x₁₁, x₁₂, . . . , x₁ₙ denote a number of insured drivers of each day of most recent n days, respectively, and x₂₁, x₂₂, . . . , x₂ₙ denote a ratio of a number of insured drivers to a number of drivers who successfully bid at the at least one insurance company of each day of the most recent n days, respectively.

In some embodiments, the driving data of the driver includes at least one driving factor and a weight of each of the at least one driving factor.

In some embodiments, to determine the driver score, the at least one processor is further directed to: determine the driver score based on the driving data of the driver according to a second formula, wherein the second formula is Driver score=−Σ(dᵢ×wᵢ), wherein dᵢ denotes a driving factor of the at least one driving factor, and wᵢ denotes the weight of the driving factor dᵢ

In some embodiments, to obtain the driving data, the at least one processor is further directed to: obtain attribution information and operation information of the driver; and preprocess the attribution information and operation information to obtain the driving data.

In some embodiments, the at least one processor is further directed to: obtain a plurality of historical accident records of a plurality of drivers; obtain a plurality of candidate factors of each of the plurality of drivers; input the plurality of historical accident records and the plurality of candidate factors of the plurality drivers into a model; for each of the plurality of candidate factors, determine a weight of each of the plurality of candidate factors attached to the plurality of historical accident records based on the model; and obtain at least one driving factor from the plurality of candidate factors based on the weight of each of the plurality of candidate factors.

In some embodiments, the plurality of candidate factors of each driver includes at least one of: a mileage of the driver as a passenger, a ratio of a number of complaints to a number of orders in a recent half year of the driver, a number of working nights in a current year of the driver, a ratio of the number of working nights to a number of working days in the current year of the driver, a mileage of the driver in the current year, a mileage of the driver in a last year, a number of days that the driver worked during rush hours in the last year, a ratio of the number of days that the driver worked during rush hours to a number of working days in the last year of the driver, the number of working days in the last year of the driver, the number of working days in the current year of the driver, a ratio of a number of days that the driver worked during rush hours to the number of working days in the current year, an average driving speed in the last year of the driver, an average driving speed in the current year of the driver, a vehicle age, a number of working nights in the last year of the driver, a ratio of the number of working nights to the number of working days in the last year of the driver, the number of days that the driver worked during rush hours in the current year, an age of the driver, an activation time of the driver, a number of cheating orders of the driver, a driving age of the driver, a number of speeding of the driver, a number of sharp turns of the driver, a number of quick accelerations of the driver, a number of quick slowdowns of the driver, an area where the driver drives, a ratio of a number of received complaint of first degree to a number of orders in the recent half year of the driver, a ratio of a number of received complaint of the second degree to a number of orders in the recent half year of the driver, or a ratio of a number of complaint of the third grade to a number of orders in the recent half year of the driver.

In some embodiments, the at least one driving factor includes at least one of: the mileage of the driver in the current year, the mileage of the driver as a passenger, the number of working nights of the driver in the current year, the ratio of the number of complaints to a number of orders of the driver in the recent half year, or the driver age of the driver.

In some embodiments, the model is a Logistic Regression model.

In some embodiments, to determine the company ranking of the at least one insurance company, the at least one processor is further directed to: identify two or more insurance companies that have a same company score; obtain a popularity ranking of the two or more insurance companies; and determine a company ranking of the two or more insurance companies based on the popularity ranking.

In some embodiments, the at least one processor is further directed to: send information relating to the at least one recommended insurance company to a user terminal, wherein the information relating to the at least one recommended insurance company includes advantageous information and disadvantageous information of the at least one recommended insurance company.

Another aspect of the present disclosure introduces a method for recommending at least one insurance company to a driver. The method includes: obtaining business data of at least one insurance company; for each of the at least one insurance company, determining a company score based on the business data of the insurance company; determining a company ranking of the at least one insurance company based on the company score of the at least one company; obtaining driving data of the driver; determining a driver score based on the driving data of the driver; and determining at least one recommended insurance company based on the company ranking of the at least one insurance company and the driver score of the driver.

Still another aspect of the present disclosure introduces a non-transitory computer readable medium. The non-transitory computer readable medium includes at least one set of instructions for recommending at least one insurance company to a driver, when executed by at least one processor, the at least one set of instructions directs the at least one processor to: obtain business data of at least one insurance company; for each of the at least one insurance company, determine a company score based on the business data of the insurance company; determine a company ranking of the at least one insurance company based on the company score of the at least one company; obtain driving data of the driver; determine a driver score based on the driving data of the driver; and determine at least one recommended insurance company based on the company ranking of the at least one insurance company and the driver score of the driver.

Still another aspect of the present disclosure introduces a system for recommending at least one insurance company to a driver, comprising: at least one network interface to communicate with a user terminal of the driver; at least one processor operably coupled to the at least one network interface, the at least one processor being directed to: detect an application executing on the user terminal, the application automatically communicating with a network service of the system over a network; communicate with the application executing on the user terminal with respect to an insurance request; wherein the at least one processor communicates with the application by: providing first data to the application executing on the user terminal to generate a presentation, on a display of the user terminal, the presentation providing a user interface feature from which the user can initiate transmission of the insurance request, and by the at least one processor, a determination process to determine at least one recommended insurance company in response to the insurance request; receiving, from the user terminal, the insurance request once the user interacts with the user interface feature; in response to receiving the insurance request, initiate the determination process, by programmatically: obtaining business data of at least one insurance company; for each of the at least one insurance company, determining a company score based on the business data of the insurance company; determining a company ranking of the at least one insurance company based on the company score of the at least one company; obtaining driving data of the driver; determining a driver score based on the driving data of the driver; and determining at least one recommended insurance company based on the company ranking of the at least one insurance company and the driver score of the driver; and provide second data including the at least one recommended insurance company to the application executing on the user interface to cause the presentation to depict the at least one recommended insurance on the display of the user terminal.

Still another aspect of the present disclosure introduces a computer-implemented method for operating one or more servers for recommending at least one insurance company to a driver, the method comprising: detecting an application executing on the user terminal, the application automatically communicating with a network service of the system over a network; communicating with the application executing on the user terminal with respect to an insurance request; wherein the at least one processor communicates with the application by: providing first data to the application executing on the user terminal to generate a presentation, on a display of the user terminal, the presentation providing a user interface feature from which the user can initiate transmission of the insurance request, and by the at least one processor, a determination process to determine at least one recommended insurance company in response to the insurance request; receiving, from the user terminal, the insurance request once the user interacts with the user interface feature; in response to receiving the insurance request, initiating the determination process, by programmatically: obtaining business data of at least one insurance company; for each of the at least one insurance company, determining a company score based on the business data of the insurance company; determining a company ranking of the at least one insurance company based on the company score of the at least one company; obtaining driving data of the driver; determining a driver score based on the driving data of the driver; and determining at least one recommended insurance company based on the company ranking of the at least one insurance company and the driver score of the driver; and providing second data including the at least one recommended insurance company to the application executing on the user interface to cause the presentation to depict the at least one recommended insurance on the display of the user terminal.

Still another aspect of the present disclosure introduces a non-transitory computer readable medium, comprising at least one set of instructions for recommending at least one insurance company to a driver, wherein when executed by at least one processor, the at least one set of instructions directs the at least one processor to: detect an application executing on the user terminal, the application automatically communicating with a network service of the system over a network; communicate with the application executing on the user terminal with respect to an insurance request; wherein the at least one processor communicates with the application by: providing first data to the application executing on the user terminal to generate a presentation, on a display of the user terminal, the presentation providing a user interface feature from which the user can initiate transmission of the insurance request, and by the at least one processor, a determination process to determine at least one recommended insurance company in response to the insurance request; receiving, from the user terminal, the insurance request once the user interacts with the user interface feature; in response to receiving the insurance request, initiate the determination process, by programmatically: obtaining business data of at least one insurance company; for each of the at least one insurance company, determining a company score based on the business data of the insurance company; determining a company ranking of the at least one insurance company based on the company score of the at least one company; obtaining driving data of the driver; determining a driver score based on the driving data of the driver; and determining at least one recommended insurance company based on the company ranking of the at least one insurance company and the driver score of the driver; and provide second data including the at least one recommended insurance company to the application executing on the user interface to cause the presentation to depict the at least one recommended insurance on the display of the user terminal.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary system for recommending at least one insurance company according to some embodiments of the present disclosure;

FIG. 5 is a flowchart illustrating an exemplary process for determining at least one recommended insurance company according to some embodiments of the present disclosure;

FIG. 6 is a flowchart illustrating an exemplary process for determining at least one recommended insurance company according to some embodiments of the present disclosure;

FIG. 7 is an exemplary user interface of an application on a user terminal according to some embodiments of the present disclosure;

FIG. 8 is an exemplary user interface of an application on a user terminal according to some embodiments of the present disclosure;

FIG. 9 is a flowchart illustrating an exemplary process for obtaining driving data of a driver according to some embodiments of the present disclosure;

FIG. 10 is a flowchart illustrating an exemplary process for obtaining at least one driving factor according to some embodiments of the present disclosure; and

FIG. 11 is a flowchart illustrating an exemplary process for determining a company ranking according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for recommending at least one insurance company to a driver. To this end, the systems and methods may match at least one proper insurance company with the driver. The matching may be achieved by matching a company ranking or company sores of a plurality of insurance companies with a driver score of the driver. The company ranking or company sores may be determined based on a number of insured drivers of each day of most recent several days and a ratio of a number of insured drivers to a number of drivers who successfully bid at the plurality of insurance companies of each day of the most recent several days. The driver score may be determined based on a plurality of driving factors extracted from driving data of the driver and a weight of each of the plurality of driving factors. The weight may show a probability that the corresponding driving factor may lead to an accident. In this way, the systems and methods may more likely recommend at least one insurance company that ranks at top of the company ranking to a driver with a higher driver score than a driver with a lower score. Under the recommendation, the driver may obtain more discounts from the at least one recommended insurance company and the corresponding insurance company may be more willing to insure the corresponding vehicle of the driver. The systems and methods may improve a trade volume between drivers and insurance companies.

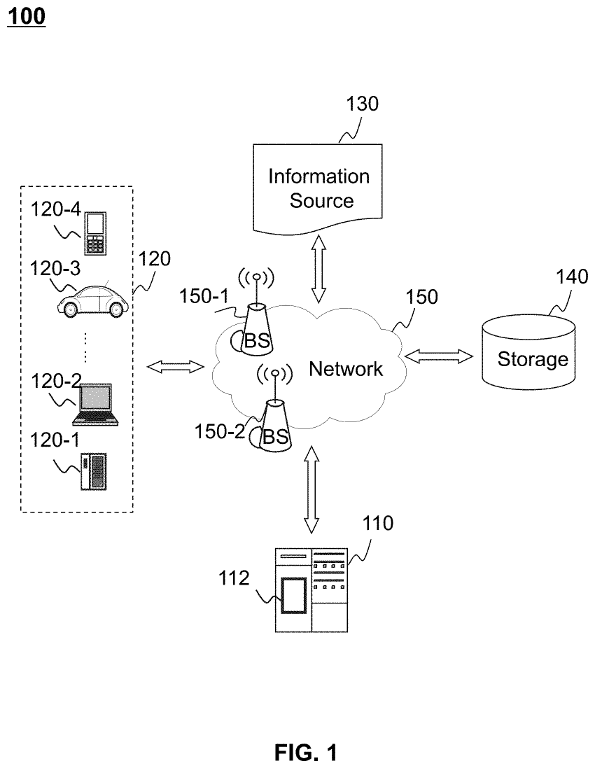

FIG. 1 is a schematic diagram of an exemplary online to offline service system 100 according to some embodiments of the present disclosure. For example, the online to offline service system 100 may be an online to offline service platform for transportation services such as car hailing, chauffeur services, delivery vehicles, carpool, bus service, driver hiring, shuttle services, and online navigation services. The online to offline service system 100 may be an online platform including a server 110, a user terminal 120, an information source 130, a storage device 140, and a network 150. The server 110 may include a processing engine 112.

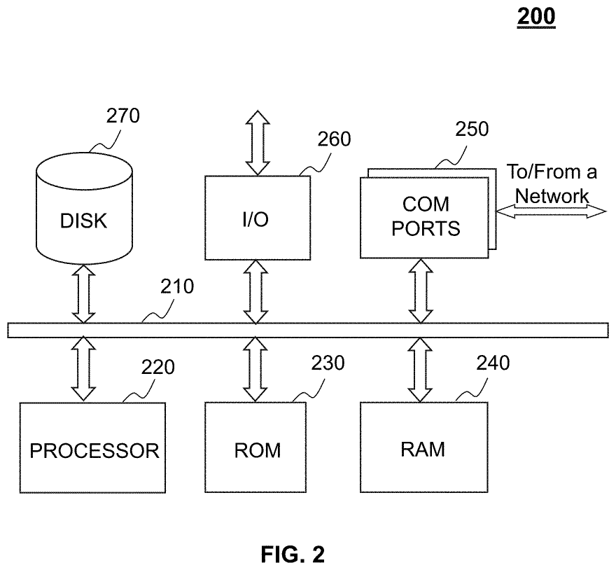

The server 110 may be configured to process information and/or data relating to recommending insurance companies to drivers. For example, the server 110 may determine at least one recommended insurance company for a vehicle of a driver. In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the user terminal 120, and/or the storage device 140 via the network 150. As another example, the server 110 may connect the user terminal 120, and/or the storage device 140 to access stored information and/or data. In some embodiments, the server 110 may be implemented on a cloud platform. Merely by way of example, the cloud platform may be a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to recommending insurance companies to drivers to perform one or more functions described in the present disclosure. For example, the processing engine 112 may determine at least one recommended insurance company for a vehicle of a driver. In some embodiments, the processing engine 112 may include one or more processing engines (e.g., single-core processing engine(s) or multi-core processor(s)). Merely by way of example, the processing engine 112 may be one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The user terminal 120 may be a mobile device used by a user of an online to offline service, such as a driver. In some embodiments, the user terminal 120 may be a mobile device, a tablet computer, a laptop computer, a built-in device in a motor vehicle, a user equipment (UE), a mobile station (MS), a terminal, or the like, or any combination thereof. In some embodiments, the mobile device may be a wearable device, a smart mobile device, a virtual reality device, an augmented reality device, or the like, or any combination thereof. In some embodiments, the wearable device may be a smart bracelet, a smart footgear, a smart glass, a smart helmet, a smart watch, a smart clothing, a smart backpack, a smart accessory, or the like, or any combination thereof. In some embodiments, the smart mobile device may be a smartphone, a personal digital assistance (PDA), a gaming device, a navigation device, a point of sale (POS) device, or the like, or any combination thereof. In some embodiments, the virtual reality device and/or the augmented reality device may be a virtual reality helmet, a virtual reality glass, a virtual reality patch, an augmented reality helmet, an augmented reality glass, an augmented reality patch, or the like, or any combination thereof. For example, the virtual reality device and/or the augmented reality device may be a Google Glass™, a RiftCon™, a Fragments™, a Gear VR™, etc. In some embodiments, built-in device in the motor vehicle may be an onboard computer, an onboard television, etc.

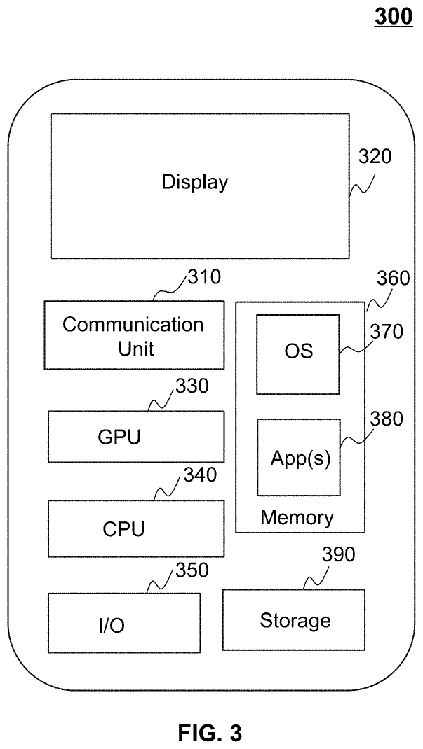

In some embodiments, the user terminal 120 may be a device with positioning technology for locating the position of the user and/or the user terminal 120. The positioning technology used in the present disclosure may be a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure. In some embodiments, the user terminal 120 may further include at least one network port. The at least one network port may be configured to send information to and/or receive information from one or more components in the system 100 (e.g., the server 110, the storage device 140) via the network 150. In some embodiments, the user terminal 120 may be implemented on a computing device 200 having one or more components illustrated in FIG. 2, or a mobile device 300 having one or more components illustrated in FIG. 3 in the present disclosure. In some embodiments, the user terminal 120 may include an application installed therein. The server 110 may be a server of a service that the application offers.

The information source 130 may be a source configured to provide other information for the system 100. The information source 130 may provide the system 100 with information relating to a plurality of insurance companies and information relating to a plurality of drivers. For example, the information source 130 may provide business data of the plurality of insurance companies. As another example, the information source 130 may provide driving data of the plurality of drivers. The information source 130 may be implemented in a single central server, multiple servers connected via a communication link, or multiple personal devices. When the information source 130 is implemented in multiple personal devices, the personal devices can generate content (e.g., as referred to as the “user-generated content”), for example, by uploading text, voice, image and video to a cloud server. An information source 130 may be generated by the multiple personal devices and the cloud server.

The storage device 140 may store data and/or instructions. For example, the storage device 140 may store data obtained from the user terminal 120. As another example, the storage device 140 may store data and/or instructions that the server 110 may execute or use to perform exemplary methods described in the present disclosure. As still another example, the storage device 140 may store data relating to a plurality of insurance companies. In some embodiments, the storage device 140 may be a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may be a private cloud, a public cloud, a hybrid cloud, a community cloud, a distributed cloud, an inter-cloud, a multi-cloud, or the like, or any combination thereof.

In some embodiments, one or more components of the online to offline service system 100 (e.g., the server 110, the user terminal 120) may access the storage device 140. In some embodiments, one or more components of the online to offline service system 100 may read and/or modify information relating to users, and/or the public when one or more conditions are met. For example, the server 110 may read and/or modify one or more users' information after completing a service.

The network 150 may facilitate exchange of information and/or data. In some embodiments, one or more components of the online to offline service system 100 (e.g., the server 110, the user terminal 120, and the storage device 140) may transmit information and/or data to other component(s) in the online to offline service system 100 via the network 150. For example, the server 110 may receive an insurance request from the user terminal 120 via the network 150. In some embodiments, the network 150 may be any type of wired or wireless network, or combination thereof. Merely by way of example, the network 150 may be a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network may include one or more network access points. For example, the network 150 may include wired or wireless network access points such as base stations and/or internet exchange points, through which one or more components of the online to offline service system 100 may be connected to the network 150 to exchange data and/or information between them.

In some embodiments, one or more components of the online to offline service system 100 (e.g., the server 110, the user terminal 120, and the storage device 140) may communicate with each other in form of electronic and/or electromagnetic signals, through wired and/or wireless communication. In some embodiments, the system 100 may further include at least one network interface. The at least one network interface may be configured to receive information and/or send information (e.g., in form of electronic signals and/or electromagnetic signals) between any electronic devices in the system 100. For example, the at least one network interface may receive an insurance request from the user terminal 120 through wireless communication between the server 110 and the user terminal 120. As another example, the at least one network interface may send electromagnetic signals including at least one recommended insurance company to the user terminal 120 through wireless communication. In some embodiments, the at least one network interface may be one or more of an antenna, a network port, or the like, or any combination thereof. For example, the at least one network interface may be a network port connected to the server 110 to send information thereto and/or receive information transmitted therefrom.

FIG. 2 is a schematic diagram illustrating exemplary hardware and software components of a computing device 200 on which the server 110, and/or the user terminal 120 may be implemented according to some embodiments of the present disclosure. For example, the processing engine 112 may be implemented on the computing device 200 and configured to perform functions of the server or the processing engine 112 disclosed in this disclosure.

The computing device 200 may be used to implement the system 100 for the present disclosure. The computing device 200 may be used to implement any component of system 100 that perform one or more functions disclosed in the present disclosure. For example, the processing engine 112 may be implemented on the computing device 200, via its hardware, software program, firmware, or a combination thereof. Although only one such computer is shown, for convenience, the computer functions relating to the online to offline service as described herein may be implemented in a distributed fashion on a number of similar platforms, to distribute the processing load.

The computing device 200, for example, may include COM ports 250 connected to and from a network connected thereto to facilitate data communications. The COM port 250 may be any network port or network interface to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. The processing circuits may also generate electronic signals including the conclusion or the result (e.g., the literal destination) and a triggering code. In some embodiments, the trigger code may be in a format recognizable by an operation system (or an application installed therein) of an electronic device (e.g., the user terminal 120) in the AI system 100. For example, the trigger code may be an instruction, a code, a mark, a symbol, or the like, or any combination thereof, that can activate certain functions and/or operations of a mobile phone or let the mobile phone execute a predetermined program(s). In some embodiments, the trigger code may be configured to rend the operation system (or the application) of the electronic device to generate a presentation of the conclusion or the result (e.g., the literal destination) on an interface of the electronic device. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The exemplary computing device may also include operation systems stored in the ROM 230, RAM 240, and/or other type of non-transitory storage medium to be executed by the processor 220. The program instructions may be compatible with the operation systems for providing the online to offline service. The computing device 200 also includes an I/O component 260, supporting input/output between the computer and other components. The computing device 200 may also receive programming and data via network communications.

Merely for illustration, only one processor is illustrated in FIG. 2. Multiple processors are also contemplated; thus, operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

FIG. 3 is a schematic diagram illustrating exemplary hardware and/or software components of an exemplary mobile device 300 on which the user terminal 120 may be implemented according to some embodiments of the present disclosure.

As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service. User interactions with the information stream may be achieved via the I/O devices 350 and provided to the processing engine 112 and/or other components of the system 100 via the network.

To implement various modules, units, and their functionalities described in the present disclosure, computer hardware platforms may be used as the hardware platform(s) for one or more of the elements described herein (e.g., the online to offline service system 100, and/or other components of the online to offline service system 100 described with respect to FIGS. 1-11). The hardware elements, operating systems and programming languages of such computers are conventional in nature, and it is presumed that those skilled in the art are adequately familiar therewith to adapt those technologies to recommend at least one insurance company to a driver as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

One of ordinary skill in the art would understand that when an element of the online to offline service system 100 performs, the element may perform through electrical signals and/or electromagnetic signals. For example, when a user terminal 120 processes a task, such as making a determination, identifying or selecting an object, the user terminal 120 may operate logic circuits in its processor to perform such task. When the user terminal 120 sends out an insurance request to the server 110, a processor of the user terminal 120 may generate electrical signals encoding the request. The processor of the user terminal 120 may then send the electrical signals to an output port. If the user terminal 120 communicates with the server 110 via a wired network, the output port may be physically connected to a cable, which further transmit the electrical signal to an input port of the server 110. If the user terminal 120 communicates with the server 110 via a wireless network, the output port of the user terminal 120 may be one or more antennas, which convert the electrical signal to electromagnetic signal. Within an electronic device, such as the user terminal 120, and/or the server 110, when a processor thereof processes an instruction, sends out an instruction, and/or performs an action, the instruction and/or action is conducted via electrical signals. For example, when the processor retrieves or saves data from a storage medium, it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

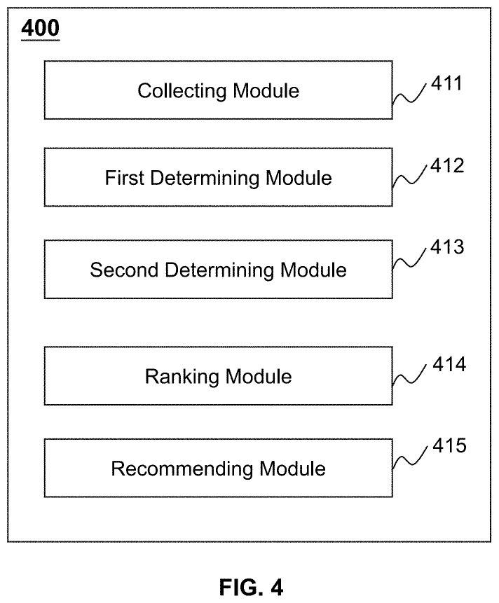

FIG. 4 is a block diagram illustrating an exemplary system for recommending at least one insurance company according to some embodiments of the present disclosure. As illustrated in FIG. 4, the system 400 may include a collecting module 411, a first determining module 412, a second determining module 413, a ranking module 414, and a recommending module 415.

The collecting module 411 may be configured to collect information and/or data relating to the driver and/or at least one recommended insurance company. In some embodiments, the collecting module 411 may obtain business data of at least one insurance company and driving data of a driver. In some embodiments, the collecting module 411 may obtain attribution information and operation information of a driver. The collecting module 411 may preprocess the attribution information and operation information to obtain driving data of the driver.

The first determining module 412 may be configured to determine a company score of an insurance company. For example, the first determining module 412 may determine the company score based on the business data of the insurance company. As another example, the first determining module 412 may process the business data and determine a company score based on the processed business data according to a first formula.

The second determining module 413 may be configured to determine a driver score of a driver. For example, the second determining module 413 may determine a driver score based on the driving data of the driver. As another example, the second determining module 413 may process the driving data and determine a driver score based on the driving data of the driver.

The ranking module 414 may be configured to determine a company ranking of the at least one insurance company. For example, the ranking module 414 may determine a company ranking of the at least one insurance company based on the company score of the at least one insurance company.

The recommending module 415 may be configured to recommend a predetermined number of insurance companies to the driver. For example, the recommending module 415 may determine at least one recommended insurance company based on the company ranking of the at least one insurance company and the driver score of the driver.

The modules in the system 400 as illustrated in FIG. 4 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the first determining module 412 and the second determining module 413 may be combined as a determining module to both determine a driver score of the diver and determine a company score of each of the at least one recommended insurance company. As another example, the processing engine 112 may include a storage module (not shown) used to store data and/or information during determining at least one recommended insurance company.

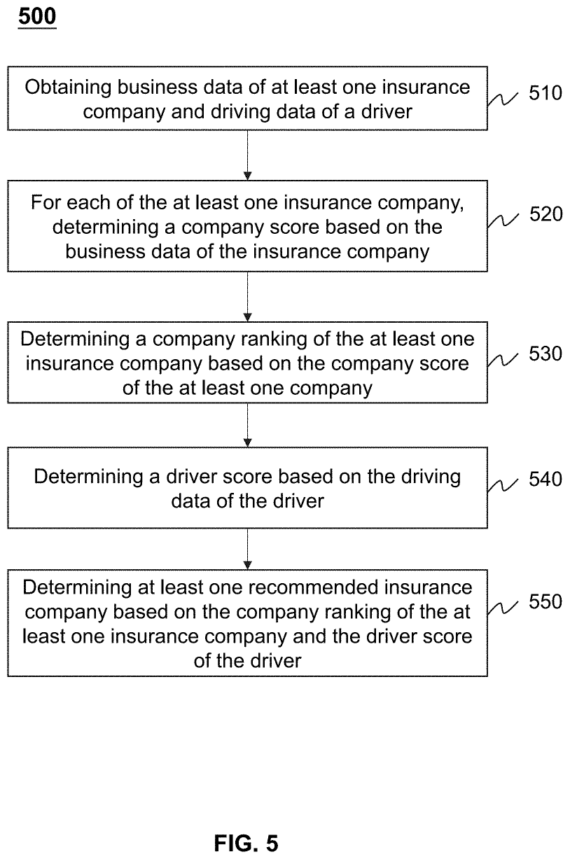

FIG. 5 is flowchart illustrating an exemplary process for determining at least one recommended insurance company according to some embodiments of the present disclosure. The process 500 may be executed by the online to offline service system 100, or a server integrating the online to offline service system 100. For example, the process 500 may be implemented as a set of instructions (e.g., an application) stored in the storage ROM 230 or RAM 240. The processor 220 may execute the set of instructions, and when executing the instructions, it may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5 and described below is not intended to be limiting.

In 510, the processing engine 112 (e.g., the processor 220, the collecting module 411) may obtain business data of at least one insurance company and driving data of a driver.

In some embodiments, the business data of an insurance company may include data during each process for purchasing vehicle insurances of the issuance company. For example, the business data of the insurance company may include a number of insured drivers of the insurance company, a number of drivers who successfully bid at the insurance company, a ratio of the number of insured drivers to the number of drivers who successfully bid at the insurance company, or the like, or any combination thereof. In some embodiments, the business data may be data of a predetermined time period. For example, the business data of an insurance company may include data during most recent several days, data of each day of most recent several days, data of a most recent month, data of most recent several months, or the like, or any combination thereof.

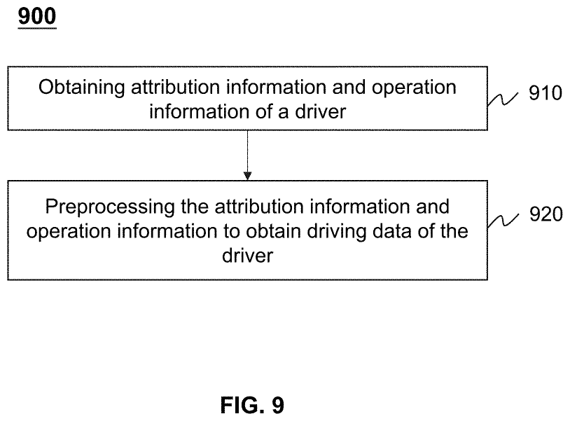

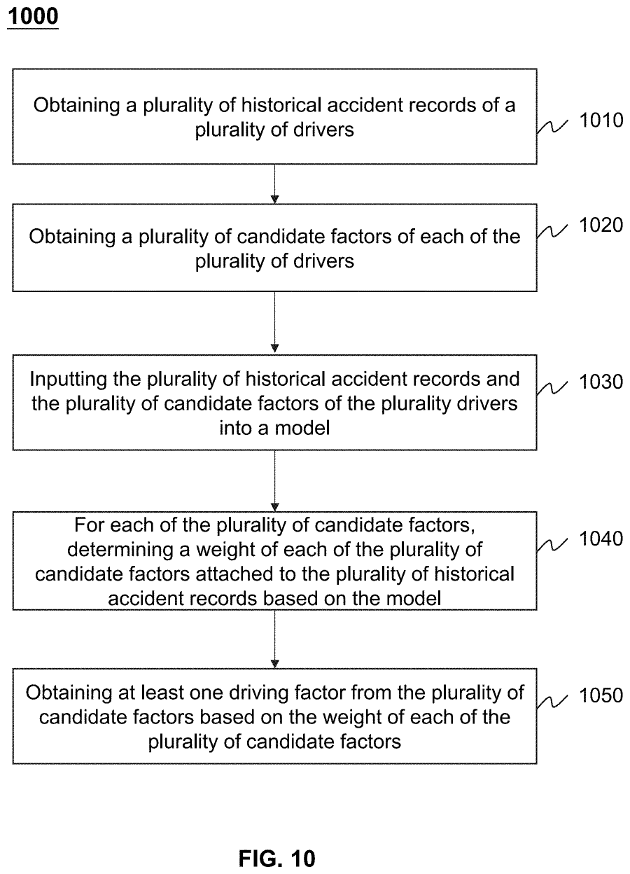

In some embodiments, the driving data of the driver may include data relating to attribution information of the driver and data relating to operation information of the driver. The attribution information may include basic information of the driver or the vehicle of the driver. For example, the attribution information may include a vehicle age, an age of the driver, a driving age of the driver, a vehicle type, or the like, or any combination thereof. The operation information of the driver may include data relating to historical orders of the driver on the online to offline platform and/or data relating to historical driving behaviors of the driver. In some embodiments, the processing engine 112 may record behaviors of the driver on the online to offline platform every day to obtain the operation information. In some embodiments, descriptions of obtaining the driving data from the attribution information and the operation information of the driver may be found elsewhere in the present disclosure (e.g., FIG. 9 and the descriptions thereof). In some embodiments, the driving data of the driver may include at least one driving factor and a weight of each of the at least one driving factor. In some embodiments, a driving factor may be a feature extracted from data relating to attribution information of the driver and data relating to operation information of the driver. In some embodiments, the weight of a driving factor may show a probability that the driving factor is attached to an accident. The higher the weight of a driving factor, the higher probability that the driving factor may lead to an accident. In some embodiments, descriptions of obtaining at least one driving factor and a weight of each of the at least one driving factor may be found elsewhere in the present disclosure (e.g., FIG. 10 and the descriptions thereof). In some embodiments, the driving data may be data of a predetermined time period. For example, the driving data of the driver may include data during most recent several days, data of each day of most recent several days, data of a most recent month, data of most recent several months, or the like, or any combination thereof.

In 520, for each of the at least one insurance company, the processing engine 112 (e.g., the processor 220, the first determining module 412) may determine a company score based on the business data of the insurance company.

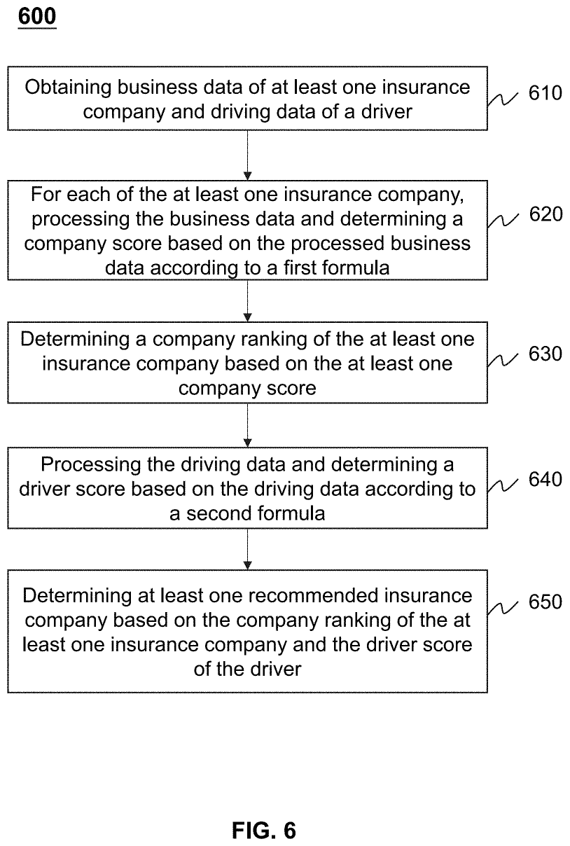

In some embodiments, the company score may be an index that indicates an overall service quality of an insurance company. The higher the company score of an insurance company, the better service quality of the insurance company. In some embodiments, the processing engine 112 may determine the company score of each of the at least one insurance company based on the business data of the corresponding insurance company according to a method and/or an algorithm. For example, the processing engine 112 may determine an algorithm for calculating the company score, and input the business data of an insurance company, such as a number of insured drivers of the insurance company, a number of drivers who successfully bid at the insurance company, a ratio of the number of insured drivers to the number of drivers who successfully bid at the insurance company, etc., into the determined algorithm to determine the company score. In some embodiments, descriptions of determining a company score of an insurance company may be found elsewhere in the present disclosure (e.g., FIG. 6 and the descriptions thereof).

In 530, the processing engine 112 (e.g., the processor 220, the ranking module 414) may determine a company ranking of the at least one insurance company based on the company score of the at least one company.

In some embodiments, the processing engine 112 may determine the company ranking according to an ascending order of the at least one company score of the at last one insurance company. Alternatively, the processing engine 112 may determine the company ranking according to a descending order of the at least one company score of the at last one insurance company. In some embodiments, the processing engine 112 may divide the at least one insurance company into a plurality of company grades. Each company grade may include a certain number of companies. For example, the at least one insurance company may be divided into a plurality of company grades according to the normal distribution. For example, the processing engine 112 may identify the company scores at the top 10%, 50%, and 40% of the company ranking, respectively. The corresponding insurance companies at the 10%, 50%, and 40% may be divided into a first company grade, a second company grade, and a third company grade, respectively. In some embodiments, the number of the company grades and/or the dividing method of different company grades may be determined by the processing engine 112 based on different application scenarios. For example, the number of company grades may be determined based on a total number of the at least one insurance company.

In 540, the processing engine 112 (e.g., the processor 220, the second determining module 413) may determine a driver score based on the driving data of the driver.

In some embodiments, the driver score may be an index that indicates a driving performance of a driver. The lower the driver score of a driver, the more probability that the driver may have a traffic accident. The lower the driver score of the driver, the more probability that an insurance company may compensate for the driver. In some embodiments, the processing engine 112 may determine the driver score of the driver based on the driving data of the driver according to a method and/or an algorithm. For example, the processing engine 112 may determine an algorithm for calculating the driver score, and input the driving data of the driver, such as a plurality of driving factors and the weights thereof, into the determined algorithm to determine the driver score. In some embodiments, descriptions of determining the driver score of the driver may be found elsewhere in the present disclosure (e.g., FIG. 6 and the descriptions thereof).

In some embodiments, the processing engine 112 may obtain driving data of each of a plurality of drivers that register on the online to offline platform. For each of the plurality of drivers, the processing engine 112 may determine a driver score based on the driving data of the driver. The processing engine 112 may further determine a driver ranking of the plurality of drivers based on the driving scores of the plurality of drivers. For example, the processing engine 112 may determine the driver ranking according to an ascending order of the plurality of driver score of the plurality of drivers. Alternatively, the processing engine 112 may determine the driver ranking according to a descending order of the plurality of driver score of the plurality of drivers. In some embodiments, the processing engine 112 may divide the plurality of drivers into a plurality of driver grades. Each driver grade may include a certain number of drivers. For example, the plurality of drivers may be divided into a plurality of driver grades according to the normal distribution. For example, the processing engine 112 may identify the driver scores at the top 20%, 40%, and 40% of the company ranking, respectively. The corresponding drivers at the 10%, 50%, and 40% may be divided into a first driver grade, a second driver grade, and a third driver grade, respectively. In some embodiments, the number of the driver grades and/or the dividing method of different driver grades may be determined by the processing engine 112 based on different application scenarios. For example, the number of driver grades may be determined based on a total number of the plurality of drivers. In some embodiments, the number of the company grades and the number of the driver grades may be same or different with each other. In some embodiments, the driver ranking and/or the driver grades may be predetermined and stored in a storage of the system 100.

In 550, the processing engine 112 (e.g., the processor 220, the recommending module 415) may determine at least one recommended insurance company based on the company ranking of the at least one insurance company and the driver score of the driver.

In some embodiments, the at least one recommended insurance company may be a predetermined number of insurance companies. The predetermined number may be determined by the processing engine according to different application scenarios. For example, the predetermined number may be a value predetermined and stored in a storage of the system 100. As another example, the predetermined number may be determined based on the driver score. The processing engine 112 may determine a greater number of recommended insurance companies to a driver with a higher driver score than a driver with a lower driver score.

In some embodiments, the processing engine 112 may match the at least one recommended insurance company with the driver based on the company ranking of the at least one insurance company and the driver score of the driver. For example, the matching between the at least one recommended insurance company and the driver may be based on a predetermined matching method. For example, the processing engine 112 may identify the driver score, and identify a predetermined number of recommended insurance companies at certain rankings of the company ranking according to the predetermined matching method. For example, if the driver score is 90, the processing engine 112 may match five top insurance companies at the top of the company ranking as the at least one recommended insurance company to recommend to the driver. As another example, if the driver score is 30, the processing engine 112 may match five last insurance companies at the bottom of the company ranking as the at least one recommended insurance company to recommend to the driver.

In some embodiments, the processing engine 112 may match the at least one recommended insurance company with the driver based on the driver grade of the driver and the insurance companies in each company grade. The processing engine may match the insurance companies that are at higher grade (i.e., at higher rankings of the company ranking) with the driver that is at higher grade (i.e., at higher ranking of the driver ranking). For example, if the driver is at a first driver grade at the top of the driver ranking, the processing engine 112 may identify the insurance companies at a first company grade at the top of the company ranking as the at least one recommended insurance company.

In some embodiments, in response to determining the at least one recommended insurance company for the driver, the processing engine 112 may send data including the at least one recommended insurance company to a user terminal of the driver. For example, the processing engine 112 may send the data to an application of the online to offline service executing on a user interface of the user terminal to cause the user terminal to display the at least one recommended insurance company. In some embodiments, the information relating to the at least one recommended insurance company may include advantageous information and disadvantageous information of the at least one recommended insurance company. The advantageous information and disadvantageous information of a recommended insurance company may include a service quality of the recommended insurance company, whether the recommended insurance company may compensate for the driver, or the like, or any combination thereof.

It should be noted that FIG. 5 only illustrates one driver to be recommended to insurance companies. A plurality of drivers may be recommended at the same time. For example, the processing engine 112 may obtain driving data of a plurality of drivers. For each of the at least one driver, the processing engine 112 determine a driver score based on the corresponding driver data, and determine at least one recommended insurance company for each driver based on the corresponding driver score and company ranking of the at least one insurance company.

FIG. 6 is a flowchart illustrating an exemplary process for determining at least one recommended insurance company according to some embodiments of the present disclosure. The process 600 may be executed by the online to offline service system 100, or a server integrating the online to offline service system 100. For example, the process 600 may be implemented as a set of instructions (e.g., an application) stored in the storage ROM 230 or RAM 240. The processor 220 may execute the set of instructions, and when executing the instructions, it may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process as illustrated in FIG. 6 and described below is not intended to be limiting.

In 610, the processing engine 112 (e.g., the processor 220, the collecting module 411) may obtain business data of at least one insurance company and driving data of a driver. Descriptions of the business data and the driving data may be found elsewhere in the present disclosure (e.g., FIG. 5 and the descriptions thereof).

In 620, for each of the at least one insurance company, the processing engine 112 (e.g., the processor 220, the first determining module 412) may process the business data and determine a company score based on the processed business data according to a first formula.

In some embodiments, before determining the company score of each insurance company, the processing engine 112 may process the business data of each insurance company. For example, the processing engine 112 may process the business data to meet the data form during determining the company score. The processing method may include a statistical algorithm, a weight algorithm, an average algorithm, or the like, or any combination thereof. As another example, the processing engine 112 may clean the business data of each insurance company to reduce error data when determining the company score.

In some embodiments, the processing engine 112 may determine a company score of each insurance company based on the processed business data according to a first formula (1).

Company score=4×[x₁₁−min(x₁₁, x₁₂, . . . , x₁ₙ)]/[max(x₁₁, x₁₂, . . . , x₁ₙ)−min(x₁₁, x₁₂, . . . , x₁ₙ)]+6×[x₂₁−min(x₂₁, x₂₂, . . . , x₂ₙ)]/[max(x₂₁, x₂₂, . . . , x₂ₙ)−min(x₂₁, x₂₂, . . . , x₂ₙ)], (1)

wherein x₁₁, x₁₂, . . . , x₁ₙ denote a number of insured drivers of each day of most recent n days, respectively; and x₂₁, x₂₂, . . . , x₂ₙ denote a ratio of a number of insured drivers to a number of drivers who successfully bid at the at least one insurance company of each day of the most recent n days, respectively.

In some embodiments, the recent n days may be determined according to different situations. For example, the recent n day may be recent three days. The processing engine 112 may determine the company score of each insurance company based on a number of insured drivers of each day of most recent three days and a ratio of a number of insured drivers to a number of drivers who successfully bid at the at least one insurance company of each day of the most recent three days according to the first formula (1). In some embodiment, the company score of each insurance company may be varied according to each insurance company's performance in actual business. The company score determined based on business data of each day of the most recent n days may instruct the processing engine 112 to make decision for recommending insurance companies.

In 630, the processing engine 112 (e.g., the processor 220, the ranking module 414) may determine a company ranking of the at least one insurance company based on the at least one company score. Description of ranking the at least one insurance company may be found elsewhere in the present disclosure (e.g., FIG. 5 and the descriptions thereof).

In 640, the processing engine 112 (e.g., the processor 220, the second determining module 413) may process the driving data and determine a driver score based on the driving data of the driver.

In some embodiments, before determining the driver score of the driver, the processing engine 112 may process the driving data. For example, the processing engine 112 may process the driving data to meet the data form during determining the driver score. The processing method may include a statistical algorithm, a weight algorithm, an average algorithm, or the like, or any combination thereof. As another example, the processing engine 112 may clean the driving data of the driver to reduce error data when determining the driver score.

In some embodiments, the processing engine 112 may extract at least one driving factor and a weight of each of the at least one driving factor from the processed driving data. In some embodiments, descriptions of obtaining the at least one driving factor and the corresponding weight may be found elsewhere in the present disclosure (e.g., FIG. 10 and the descriptions thereof). In some embodiments, the processing engine 112 may determine the driver score of the driver based on the processed driving data according to a second formula (2).

Driver score=−Σ(dᵢ×wᵢ), (2)

wherein dᵢ denotes a driving factor of the at least one driving factor, and wᵢ denotes the weight of the driving factor dᵢ.

In some embodiments, the driving factor may include a mileage of the driver in the current year, a mileage of the driver as a passenger, a number of working nights of the driver in the current year, a ratio of a number of complaints to a number of orders of the driver in the recent half year, a number of driving years of the driver, or the like, or any combination thereof. In some embodiments, the weight of each of the at least one driving factor may be determined based on a model as illustrated in FIG. 10 and the descriptions thereof in the present disclosure. For example, the processing engine 112 may input a plurality of historical accident records of the driver and a plurality of candidate factor of the driver into a trained model (e.g., a trained Logistic Regression model trained by a plurality of historical accident records of a plurality of drivers and a plurality of candidate factors of each of the plurality of drivers). The output of the trained model may include the at least one driving factor and the weight of each of the at least one driving factor. In some embodiments, the weight of each of the at least one driving factor may be a numerical value determined by the trained model. Merely by way of example, the weights of the mileage of the driver in the current year, the mileage of the driver as a passenger, the number of working nights of the driver in the current year, and the ratio of the number of complaints to the number of orders of the driver in the recent half year, and the number of driving years of the driver may be 0.49, 0.93, 0.54, 0.63, and 1.17, respectively. In some embodiments, the mileage of the driver in the current year, the mileage of the driver as a passenger, the number of working nights of the driver in the current year, and the ratio of the number of complaints to the number of orders of the driver in the recent half year may be positively correlated with an accident that the driver may have. The number of driving years of the driver may be negatively correlated with an accident that the driver may have.

In 650, the processing engine 112 (e.g., the processor 220, the recommending module 415) may determine at least one recommended insurance company based on the company ranking of the at least one insurance company and the driver score of the driver. Description of matching the at least one insurance company with the driver may be found elsewhere in the present disclosure (e.g., FIG. 5 and the descriptions thereof).

It should be noted that FIG. 6 only illustrates one driver to be recommended to insurance companies. A plurality of drivers may be recommended at the same time. For example, the processing engine 112 may obtain driving data of a plurality of drivers. For each of the at least one driver, the processing engine 112 determine a driver score based on the corresponding driver data, and determine at least one recommended insurance company for each driver based on the corresponding driver score and company ranking of the at least one insurance company.

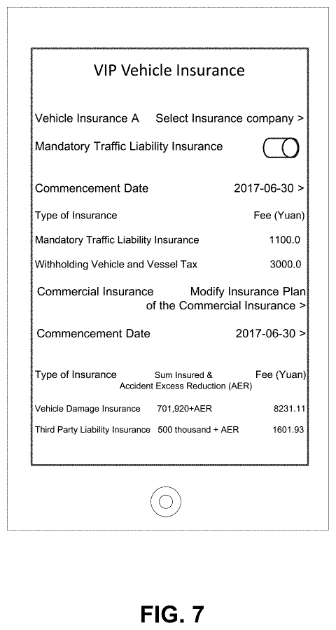

FIG. 7 is an exemplary user interface of an application on a user terminal according to some embodiments of the present disclosure. In some embodiments, the processing engine 112 may match the insurance companies corresponding to a city of the driver to the driver. For example, the processing engine 112 may identify an area of the driver according to a license plate number of the corresponding vehicle of the diver. The processing engine 112 may recommend at least one insurance company in the identified area to the driver. The area may include a country, a province, a city, a district, or the like, or any combination thereof.

TABLE 1

| | | Local Default | |
|---|---|---|---|
| Province | City | Insurance Company | Company Ranking |
| Beijing | Beijing | Insurance Company | 1- Insurance Company A |
| | | A | 2- Insurance Company B |
| | | | 3- Insurance Company D |
| | | | 4- Insurance Company C |
| Tianjin | Tianjin | Insurance Company | 1- Insurance Company C |
| | | B | 2- Insurance Company D |
| | | | 3- Insurance Company B |
| | | | 4- Insurance Company A |
| Hebei | Langfang, | Insurance Company | 1- Insurance Company B |
| | Zhangjiakou, | C | 2- Insurance Company C |
| | Chengde, | | 3- Insurance Company D |
| | Baoding | | 4- Insurance Company A |
| Shanxi | Taiyuan, | Insurance Company | 1- Insurance Company A |
| | Datong, | D | 2- Insurance Company C |
| | Jincheng, | | 3- Insurance Company B |
| | Jinzhong | | 4- Insurance Company D |

As shown in Table. 1, each city of a province may include a default insurance company. The default insurance company may be determined based on a policy of each city. For example, the default insurance company of Beijing is Insurance Company A. In some embodiments, the processing engine 112 may determine a company ranking based on the company scores of at least one insurance company. For example, in Beijing, the company ranking may be that the first is Insurance Company A, the second is Insurance Company B, the third is Insurance Company D, and the fourth is Insurance Company C. The processing engine 112 may recommend Insurance Company A to drivers that have high driver scores (or rank at top of the driver ranking, or rank at top grade in the driving ranking) in Beijing. As shown in FIG. 7, a user terminal of a driver that have high driver scores (or rank at top of the driver ranking, or rank at top grade in the driving ranking) in Beijing may display information relating to the Insurance Company A. The user interface of the user terminal may display insurance types of different vehicle insurances and the corresponding commencement date of each insurance type. In some embodiments, the driver of the user terminal may click “Select Insurance Company” on the user interface to select other insurance companies.

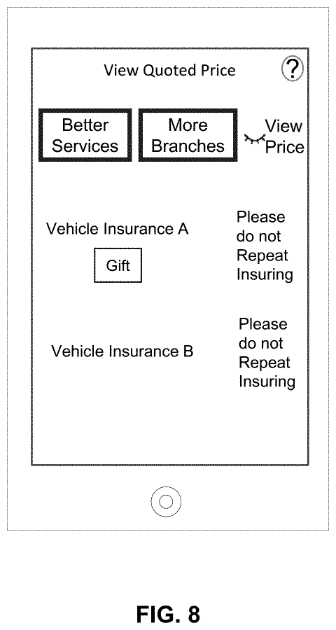

FIG. 8 is an exemplary user interface of an application on a user terminal according to some embodiments of the present disclosure. In some embodiments, the driver of the user terminal may view a price of each insurance company and/or insurance type. As shown in FIG. 8, the diver may also click “Better Services” or “More Branches” on the user interface to view corresponding insurance companies that provide better services or have more branches than the currently displayed insurance company.

FIG. 9 is a flowchart illustrating an exemplary process for obtaining driving data of a driver according to some embodiments of the present disclosure. The process 900 may be executed by the online to offline service system 100, or a server integrating the online to offline service system 100. For example, the process 900 may be implemented as a set of instructions (e.g., an application) stored in the storage ROM 230 or RAM 240. The processor 220 may execute the set of instructions, and when executing the instructions, it may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process as illustrated in FIG. 9 and described below is not intended to be limiting.

In 910, the processing engine 112 (e.g., the processor 220, the collecting module 411) may obtain attribution information and operation information of a driver.

In some embodiments, the attribution information may include basic information of the driver or the vehicle of the driver. For example, the attribution information may include a vehicle age, an age of the driver, a driving age of the driver, a vehicle type, or the like, or any combination thereof. The operation information of the driver may include data relating to historical orders of the driver on the online to offline platform and/or data relating to historical driving behaviors of the driver. In some embodiments, the processing engine 112 may record behaviors of the driver on the online to offline platform every day to obtain the operation information

In 920, the processing engine 112 (e.g., the processor 220, the collecting module 411) may preprocess the attribution information and operation information to obtain driving data of the driver.

In some embodiments, the processing engine 112 may preprocess the behaviors of the driver of every day on the online to offline platform to obtain the driving data. In some embodiments, the driving data may be data of a predetermined time period. For example, the driving data of the driver may include data during most recent several days, data of each day of most recent several days, data of a most recent month, data of most recent several months, or the like, or any combination thereof. For example, the processing engine 112 may add mileages of the driver of each day that the driver drives in the current year to obtain a mileage of the driver in the current year. As another example, the processing engine 112 calculates a time difference between the date of buying the vehicle of the driver and the current date to obtain a vehicle age. In some embodiments, the preprocessing method may be any algorithm or method for obtaining the driving data from the original attribution information and operation information of the driver.

FIG. 10 is a flowchart illustrating an exemplary process for obtaining at least one driving factor according to some embodiments of the present disclosure. The process 1000 may be executed by the online to offline service system 100, or a server integrating the online to offline service system 100. For example, the process 1000 may be implemented as a set of instructions (e.g., an application) stored in the storage ROM 230 or RAM 240. The processor 220 may execute the set of instructions, and when executing the instructions, it may be configured to perform the process 1000. The operations of the illustrated process presented below are intended to be illustrative. In some embodiments, the process 1000 may be accomplished with one or more additional operations not described and/or without one or more of the operations discussed. Additionally, the order in which the operations of the process as illustrated in FIG. 10 and described below is not intended to be limiting.

In 1010, the processing engine 112 (e.g., the processor 220) may obtain a plurality of historical accident records of a plurality of drivers.

In some embodiments, the plurality of drivers may include drivers that registered on the online to offline platform. The plurality of historical accident records of the plurality of drivers may be obtained from historical insurance records from the at least one insurance company. For example, when a vehicle of a driver has an accident, the driver may report the accident to an insurance company that insures the vehicle for compensation. In some embodiments, the plurality of historical accident records may be obtained from the at least one insurance company. In some embodiments, each driver of the plurality of drivers may have at least one historical accident record. In another embodiment, the plurality of historical accident records of the plurality of drivers may be obtained from public records, for example, police reports or vehicle registrations. Additionally, the plurality of historical accident records of the plurality of drivers may also be obtained from a car-hailing service provider.

In 1020, the processing engine 112 (e.g., the processor 220) may obtain a plurality of candidate factors of each of the plurality of drivers.

In some embodiments, the plurality of candidate factors of each of the plurality of drivers may be extracted from the attribution information and the operation information of each of the plurality of drivers. In some embodiments, the plurality of candidate factors of each of the plurality of drivers may include a mileage of the driver as a passenger, a ratio of a number of complaints that the driver obtained to a number of orders that the driver served in a recent half year, a number of working nights that the diver worked in a current year, a ratio of the number of working nights that the driver worked to a number of working days that the driver worked in the current year, a mileage of the driver in the current year, a mileage of the driver in a last year, a number of days that the driver worked during rush hours in the last year, a ratio of the number of days that the driver worked during rush hours to a number of working days in the last year, the number of working days that the driver worked in the last year, the number of working days that the driver works in the current year, a ratio of a number of days that the driver worked during rush hours to the number of working days in the current year, an average driving speed in the last year of the driver, an average driving speed in the current year of the driver, a vehicle age, a number of working nights that the driver worked in the last year, a ratio of the number of working nights that the driver worked to the number of working days that the driver worked in the last year, the number of days that the driver worked during rush hours in the current year, an age of the driver, an activation time of the driver, a number of cheating orders of the driver, a driving age of the driver, a number of speeding of the driver, a number of sharp turns of the driver, a number of quick accelerations of the driver, a number of quick slowdowns of the driver, an area where the driver drives, a ratio of a number of received complaint of first degree that the diver received to a number of orders that the driver served in the recent half year, a ratio of a number of received complaint of the second degree that the driver received to a number of orders that the driver served in the recent half year, a ratio of a number of complaint of the third grade that the driver received to a number of orders that the driver served in the recent half year, or the like, or any combination thereof. In some embodiments, each of the plurality of candidate factors may include data during a predetermined period of time. For example, the predetermined period of time may include the last year, the current year, the recent half year, a period of time from registering on the online to offline platform to the current date, or the like, or any combination thereof. For example, the number of speeding may be a number of speeding of a driver in the current year. The number of sharp turns may be a number of sharp turns in the current year. The number of quick accelerations may be a number of quick accelerations in the current year. The number of quick slowdowns may be a number of quick slowdowns in the current year.

In 1030, the processing engine 112 (e.g., the processor 220) may input the plurality of historical accident records and the plurality of candidate factors of the plurality drivers into a model.

In some embodiments, the model may be a method and/or algorithm for predicting factors that have a great impact on the historical accident records and the corresponding impact probabilities. In some embodiments, the model may be a Logistic Regression model. In some embodiments, the processing engine 112 may input the plurality of historical accident records and the plurality of candidate factor of the plurality drivers into an initial Logistic Regression model to train the Logistic Regression model. For example, the processing engine 112 may input the number of historical accident records of each of the plurality of drivers and the corresponding candidate factors of the corresponding driver into the initial Logistic Regression model.

In 1040, for each of the plurality candidate factors, the processing engine 112 (e.g., the processor 220) may determine a weight of each of the plurality of candidate factors attached to the plurality of historical accident records based on the model.

In some embodiments, the trained model may output a plurality of weights. Each weight may correspond to a candidate factor of the plurality of candidate factors. The weight of each candidate factor may be a probability that the candidate factor is attached to the plurality of historical accident records. For example, the weight of each candidate factor may be an impact that the corresponding candidate factor causes the accidents of the plurality of historical accident records. The higher the weight of a candidate factor, the more probability that the corresponding candidate factor may lead to an accident.

In 1050, the processing engine 112 (e.g., the processor 220) may obtain at least one driving factor from the plurality of candidate factors based on the weight of the each of the plurality of candidate factors.

In some embodiment, the processing engine 112 may determine a factor ranking of the plurality of candidate factors according to a descending order of the weight of the each of the plurality of candidate factors. In some embodiments, the processing engine 112 may select the at least one driving factor that has greater weight from the plurality of candidate factors. For example, the processing engine 112 may select six candidate factors from the plurality of candidate factors as the at least one driving factor for determining the driver score. The at least one driving factor may include the mileage of the driver in the current year, the mileage of the driver as a passenger, the number of working nights of the driver in the current year, the ratio of the number of complaints to a number of orders of the driver in the recent half year, the driver age of the driver, or the like, or any combination thereof. In some embodiments, the processing engine 112 may also obtain the weight of each of the at least one driving factor. In some embodiments, the processing engine 112 may using the at least one driving factor and the corresponding weight of each of the at least one driving factor to determine a driver score of a driver according to the second formal (2) as illustrated in FIG. 6 and the descriptions thereof.

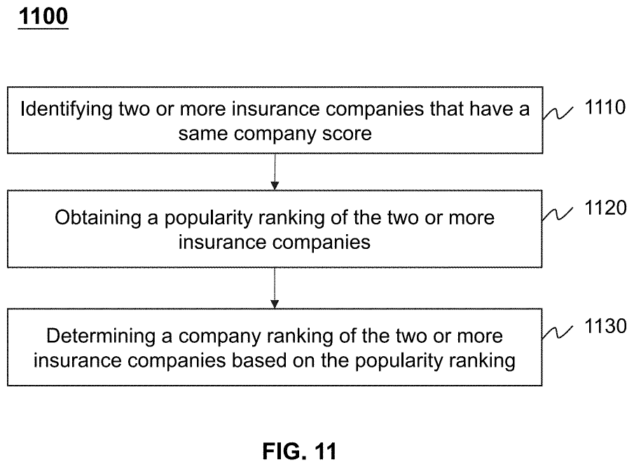

FIG. 11 is a flowchart illustrating an exemplary process for determining a company ranking according to some embodiments of the present disclosure. The process 1100 may be executed by the online to offline service system 100, or a server integrating the online to offline service system 100. For example, the process 1100 may be implemented as a set of instructions (e.g., an application) stored in the storage ROM 230 or RAM 240. The processor 220 may execute the set of instructions, and when executing the instructions, it may be configured to perform the process 1100. The operations of the illustrated process presented below are intended to be illustrative. In some embodiments, the process 1100 may be accomplished with one or more additional operations not described and/or without one or more of the operations discussed. Additionally, the order in which the operations of the process as illustrated in FIG. 11 and described below is not intended to be limiting.

In 1110, the processing engine 112 (e.g., the processor 220) may identify two or more insurance companies that have a same company score.

In some embodiments, if there are two or more insurance companies that have a same company score, the processing engine 112 may identify the corresponding insurance companies to further determine a company ranking of the identified two or more insurance companies.

In 1120, the processing engine 112 (e.g., the processor 220) may obtain a popularity ranking of the two or more insurance companies.

In some embodiments, the popularity ranking may be a ranking of known degrees by the public of the two or more insurance companies. More famous of an insurance company, the higher ranking of the insurance company in the popularity ranking. In some embodiments, the popularity ranking may be determined by a third party and be published. For example, the processing engine 112 may obtain the popularity ranking of the two or more insurance companies from a website.

In 1130, the processing engine 112 (e.g., the processor 220) may determine a company ranking of the two or more insurance companies based on the popularity ranking.

In some embodiments, an insurance company that is more famous (i.e., ranks higher in the popularity ranking) among the identified two or more insurance companies may be ranked at higher in the company ranking. The company ranking determined based on the popularity ranking may avoid a disordered company ranking, and makes the ranking comprehensive.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the descriptions, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

1-25. (canceled)

26. A system for recommending at least one insurance company to a driver, the system comprising:
at least one network interface to communicate with a user terminal of the driver;
at least one processor operably coupled to the at least one network interface, the at least one processor being directed to:
detect an application executing on the user terminal, the application automatically communicating with a network service of the system over a network;
communicate with the application executing on the user terminal with respect to an insurance request;
wherein the at least one processor communicates with the application by:
providing first data to the application executing on the user terminal to generate a presentation on a display of the user terminal, the presentation providing a user interface feature from which the user can initiate transmission of the insurance request, and a determination process can be initiated by the at least one processor, to determine at least one recommended insurance company in response to the insurance request;
receiving, from the user terminal, the insurance request once the user interacts with the user interface feature;
in response to receiving the insurance request, initiate the determination process, by programmatically:
obtaining business data of at least one insurance company;
for each of the at least one insurance company, determining a company score based on the business data of the insurance company;
determining a company ranking of the at least one insurance company based on the company score of each of the at least one company;
obtaining driving data of the driver;
determining a driver score based on the driving data of the driver; and
determining at least one recommended insurance company based on the company ranking of the at least one insurance company and the driver score of the driver; and
provide second data including the at least one recommended insurance company to the application executing on the user interface to cause the presentation to depict the at least one recommended insurance on the display of the user terminal.

27. The system of claim 26, wherein the business data of the at least one insurance company includes at least one of a count of insured drivers or a ratio of the count of insured drivers to a count of drivers who successfully bid at the at least one insurance company.

28. The system of claim 27, wherein for each of the at least one insurance company, to determine the company score, the at least one processor is further directed to:
determine the company score based on the business data according to a first formula, wherein the first formula is Company score=4×[x₁₁−min(x₁₁, x₁₂, . . . , x₁ₙ)]/[max(x₁₁, x₁₂, . . . , x₁ₙ)−min(x₁₁, x₁₂, . . . , x₁ₙ)]+6×[x₂₁−min(x₂₁, x₂₂, . . . , x₂ₙ)]/[max(x₂₁, x₂₂, . . . , x₂ₙ)−min(x₂₁, x₂₂, . . . , x₂ₙ)], wherein
x₁₁, x₁₂, . . . , x₁ₙ denote a count of insured drivers of each day of most recent n days, respectively, and
x₂₁, x₂₂, . . . , x₂ₙ denote a ratio of a count of insured drivers to a count of drivers who successfully bid at the at least one insurance company of each day of the most recent n days, respectively.

29. The system of claim 26, wherein the driving data of the driver includes at least one driving factor and a weight of each of the at least one driving factor.

30. The system of claim 29, wherein to determine the driver score, the at least one processor is further directed to:
determine the driver score based on the driving data of the driver according to a second formula, wherein the second formula is Driver score=−Σ(dᵢ×wᵢ), wherein
dᵢ denotes a driving factor of the at least one driving factor and wᵢ denotes the weight of the driving factor dᵢ.

31. The system of claim 26, wherein to obtain the driving data, the at least one processor is further directed to:
obtain attribution information and operation information of the driver; and
obtain the driving data by preprocessing the attribution information and operation information.

32. The system of claim 26, wherein the at least one processor is further directed to:
obtain a plurality of historical accident records of a plurality of drivers;
obtain a plurality of candidate factors of each of the plurality of drivers;
input the plurality of historical accident records and the plurality of candidate factors of the plurality drivers into a model;
for each of the plurality of candidate factors, determine a weight of each of the plurality of candidate factors attached to the plurality of historical accident records based on the model; and
obtain at least one driving factor from the plurality of candidate factors based on the weight of each of the plurality of candidate factors.

33. The system of claim 32, wherein the plurality of candidate factors of each driver includes at least one of:
a mileage of the driver as a passenger, a ratio of a count of complaints to a count of orders in a recent half year of the driver, a count of working nights in a current year of the driver, a ratio of the count of working nights to a count of working days in the current year of the driver, a mileage of the driver in the current year, a mileage of the driver in a last year, a count of days that the driver worked during rush hours in the last year, a ratio of the count of days that the driver worked during rush hours to a count of working days in the last year of the driver, the count of working days in the last year of the driver, the count of working days in the current year of the driver, a ratio of a count of days that the driver worked during rush hours to the count of working days in the current year, an average driving speed in the last year of the driver, an average driving speed in the current year of the driver, a vehicle age, a count of working nights in the last year of the driver, a ratio of the count of working nights to the count of working days in the last year of the driver, the count of days that the driver worked during rush hours in the current year, an age of the driver, an activation time of the driver, a count of cheating orders of the driver, a driving age of the driver, a count of speeding of the driver, a count of sharp turns of the driver, a count of quick accelerations of the driver, a count of quick slowdowns of the driver, an area where the driver drives, a ratio of a count of received complaint of first degree to a count of orders in the recent half year of the driver, a ratio of a count of received complaint of the second degree to a count of orders in the recent half year of the driver, or a ratio of a count of complaint of the third grade to a count of orders in the recent half year of the driver.

34. The system of claim 33, wherein the at least one driving factor includes at least one of:
the mileage of the driver in the current year, the mileage of the driver as a passenger, the count of working nights of the driver in the current year, the ratio of the count of complaints to a count of orders of the driver in the recent half year, or the driver age of the driver.

35. The system of claim 32, wherein the model is a Logistic Regression model.

36. The system of claim 26, wherein to determine the company ranking of the at least one insurance company, the at least one processor is further directed to:
identify two or more insurance companies that have a same company score;
obtain a popularity ranking of the two or more insurance companies; and
determine a company ranking of the two or more insurance companies based on the popularity ranking.

37. The system of claim 26, wherein the at least one processor is further directed to:
send information relating to the at least one recommended insurance company to a user terminal, wherein the information relating to the at least one recommended insurance company includes advantageous information and disadvantageous information of the at least one recommended insurance company.

38. A computer-implemented method for operating one or more servers for recommending at least one insurance company to a driver, the method comprising:
detecting an application executing on the user terminal, the application automatically communicating with a network service of the system over a network;
communicating with the application executing on the user terminal with respect to an insurance request;
wherein the at least one processor communicates with the application by:
providing first data to the application executing on the user terminal to generate a presentation on a display of the user terminal, the presentation providing a user interface feature from which the user can initiate transmission of the insurance request, and a determination process can be initiated by the at least one processor, to determine at least one recommended insurance company in response to the insurance request;
receiving, from the user terminal, the insurance request once the user interacts with the user interface feature;
in response to receiving the insurance request, initiating the determination process, by programmatically:
obtaining business data of at least one insurance company;
for each of the at least one insurance company, determining a company score based on the business data of the insurance company;
determining a company ranking of the at least one insurance company based on each of the at least one company score;
obtaining driving data of the driver;
determining a driver score based on the driving data of the driver; and
determining at least one recommended insurance company based on the company ranking of the at least one insurance company and the driver score of the driver; and
providing second data including the at least one recommended insurance company to the application executing on the user interface to cause the presentation to depict the at least one recommended insurance on the display of the user terminal.

39. The method of claim 38, wherein the business data of the at least one insurance company includes at least one of a count of insured drivers or a ratio of the count of insured drivers to a count of drivers who successfully bid at the at least one insurance company.

40. The method of claim 39, wherein for each of the at least one insurance company, the determining a company score further includes:
determining the company score based on the business data according to a first formula, wherein the first formula is Company score=4×[x₁₁−min(x₁₁, x₁₂, . . . , x₁ₙ)]/[max(x₁₁, x₁₂, . . . , x₁ₙ)−min(x₁₁, x₁₂, . . . , x₁ₙ)]+6×[x₂₁−min(x₂₁, x₂₂, . . . , x₂ₙ)]/[max(x₂₁, x₂₂, . . . , x₂ₙ)−min(x₂₁, x₂₂, . . . , x₂ₙ)], wherein
x₁₁, x₁₂, . . . , x₁ₙ denote a count of insured drivers of each day of most recent n days, respectively, and
x₂₁, x₂₂, . . . , x₂ₙ denote a ratio of a count of insured drivers to a count of drivers who successfully bid at the at least one insurance company of each day of the most recent n days, respectively.

41. The method of claim 38, wherein the driving data of the driver includes at least one driving factor and a weight of each of the at least one driving factor.

42. The method of claim 41, wherein the determining the driver score further includes:
determining the driver score based on the driving data of the driver according to a second formula, wherein the second formula is Driver score=−Σ(dᵢ×wᵢ), wherein
dᵢ denotes a driving factor of the at least one driving factor and wᵢ denotes the weight of the driving factor dᵢ.

43. The method of claim 38, wherein the obtaining the driving data further includes:
obtaining attribution information and operation information of the driver; and
obtaining the driving data by preprocessing the attribution information and operation information.

44. The method of claim 38, further comprising:
obtaining a plurality of historical accident records of a plurality of drivers;
obtaining a plurality of candidate factors of each of the plurality of drivers;
inputting the plurality of historical accident records and the plurality of candidate factors of the plurality drivers into a model;
for each of the plurality of candidate factors, determining a weight of each of the plurality of candidate factors attached to the plurality of historical accident records based on the model; and
obtaining at least one driving factor from the plurality of candidate factors based on the weight of each of the plurality of candidate factors.

45-49. (canceled)

50. A non-transitory computer readable medium, comprising at least one set of instructions for recommending at least one insurance company to a driver, wherein when executed by at least one processor, the at least one set of instructions directs the at least one processor to:
detect an application executing on the user terminal, the application automatically communicating with a network service of the system over a network;
communicate with the application executing on the user terminal with respect to an insurance request;
wherein the at least one processor communicates with the application by:
providing first data to the application executing on the user terminal to generate a presentation on a display of the user terminal, the presentation providing a user interface feature from which the user can initiate transmission of the insurance request, and a determination process can be initiated by the at least one processor, to determine at least one recommended insurance company in response to the insurance request;
receiving, from the user terminal, the insurance request once the user interacts with the user interface feature;
in response to receiving the insurance request, initiate the determination process, by programmatically:
obtaining business data of at least one insurance company;
for each of the at least one insurance company, determining a company score based on the business data of the insurance company;
determining a company ranking of the at least one insurance company based on each of the at least one company score;
obtaining driving data of the driver;
determining a driver score based on the driving data of the driver; and
determining at least one recommended insurance company based on the company ranking of the at least one insurance company and the driver score of the driver; and
provide second data including the at least one recommended insurance company to the application executing on the user interface to cause the presentation to depict the at least one recommended insurance on the display of the user terminal.
